(19) United States
(12) Patent Application Publication
(10) Pub. No.: US 2020/0320857 A1
(43) Pub. Date: Oct. 8, 2020

(54) UNMANNED SYSTEM (US) FOR SAFETY DEVICE TESTING

(71) Applicant: Honeywell International Inc., Morris Plains, NJ (US)

(72) Inventors: Scott Lang, Geneva, IL (US); Michael Lynch, Madison, CT (US); Donna Burns, Wayzata, MN (US); Rich Lau, New York City, NY (US)

(21) Appl. No.: 16/376,641

(22) Filed: Apr. 5, 2019

(51) Int. Cl. G08B 29/14; B64C 39/02

(52) U.S. Cl. CPC G08B 29/145; B64C 2201/123; B64C 39/024

(57) ABSTRACT

Methods, devices, and systems for an unmanned system (US) for safety device testing are described herein. In some examples, one or more embodiments include a test kit, a memory, and a processor to execute executable instructions stored in the memory to determine a location of a safety device to be tested, navigate, in response to the location of the safety device being different from a location of the US, the US to the location of the safety device, and initiate, in response to the location of the US and the location of the safety device being the same, a testing of the safety device using the test kit.

### TECHNICAL FIELD

The present disclosure relates to methods, devices, and systems for an unmanned system (US) for safety device testing.

### BACKGROUND

Facilities, such as commercial facilities, office buildings, hospitals, and the like, may have control systems that can be used during an emergency situation to manage an emergency event in and/or around the facility. Such control systems may rely on safety devices such as smoke detectors, heat detectors, carbon monoxide (CO) detectors, among other types of safety devices, to detect an emergency event.

Servicing of safety devices may be performed to ensure operation of such devices during an emergency event. For example, maintenance and/or testing of such safety devices can ensure such safety devices operate as intended in a situation in which an emergency event is taking place. Further, such servicing may be required by laws and/or other regulations in the area in which a facility including such devices is located.

### BRIEF DESCRIPTION OF THE DRAWINGS

FIG. 1 is an example of a system for a US for safety device testing, in accordance with one or more embodiments of the present disclosure.

FIG. 2 is an example of a system including a safety device and an unmanned aerial system (UAS) for safety device testing, in accordance with one or more embodiments of the present disclosure.

FIG. 3 is an example of a system including a safety device and an unmanned ground system (UGS) for safety device testing, in accordance with one or more embodiments of the present disclosure.

FIG. 4 is an example of a method for safety device testing using a US, in accordance with one or more embodiments of the present disclosure.

FIG. 5 is an example of a controller for a US for safety device testing, in accordance with one or more embodiments of the present disclosure.

### DETAILED DESCRIPTION

Methods, devices, and systems for an unmanned system (US) for safety device testing are described herein. In some examples, one or more embodiments include a US for safety device testing comprising a test kit, a memory, and a processor to execute instructions stored in the memory to determine a location of a safety device to be tested, navigate, in response to the location of the safety device being different from a location of the US, the US to the location of the safety device, and initiate, in response to the location of the US and the location of the safety device being the same, a testing of the safety device using the test kit.

Safety devices may be utilized in a facility to detect emergency events. As used herein, the term “safety device” refers to a device designed to detect and/or report a change in an environment in which the safety device is located. For example, safety devices may include various types of sensors to detect changes in an environment, such as a facility, which may be associated with an emergency event. The safety devices can activate in response to detection of a change in the environment in which the safety device is located. Examples of such safety devices can include smoke detectors, heat detectors, and carbon monoxide detectors, as will be further described herein.

Safety devices utilized in a facility may be serviced to ensure such devices can operate as intended in an emergency event. Some safety devices may be located in hard to reach areas. For instance, a safety device may be located near a ceiling. Servicing of such a safety device may require a technician to use a ladder or other ways to reach the safety device. Servicing of such safety devices can pose certain risks to technicians due to the difficult to reach locations of such safety devices.

A US for safety device testing, in accordance with the present disclosure, can allow for servicing of safety devices located in hard to reach areas of a facility. For instance, a US can access safety devices located in areas which may pose risks for technicians to service using traditional methods, such as using a ladder. Accordingly, safety devices may be serviced by a US, which can reduce the risk of injury to a technician by preventing the technician from having to access safety devices themselves.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

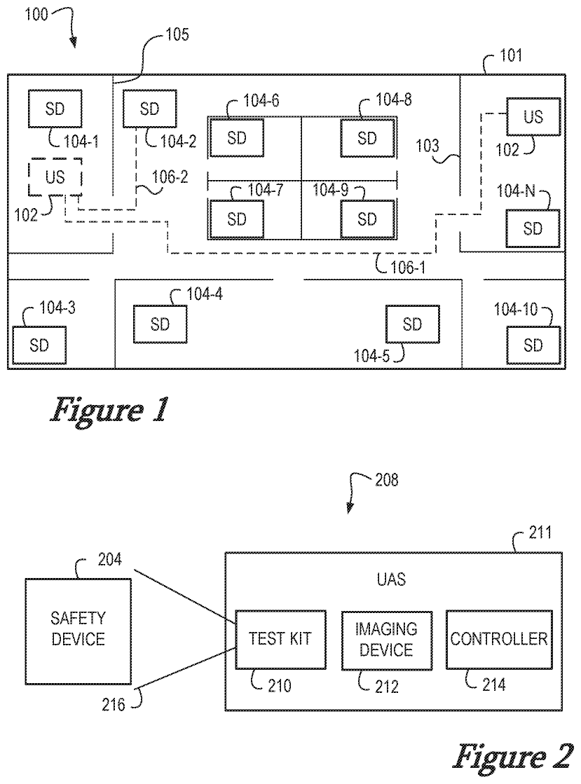

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designator “N”, as used herein particularly with respect to reference numerals in the drawings, indicates that a number of the particular feature so designated can be included with a number of embodiments of the present disclosure. This number may be the same or different between designations.

FIG. 1 is an example of a system 100 for a US 102 for safety device testing, in accordance with one or more embodiments of the present disclosure. As illustrated in FIG. 1, the system 100 can include facility 101, US 102, area 103, safety devices (e.g., SD) 104-1, 104-2, 104-3, 104-4, 104-5, 104-6, 104-7, 104-8, 104-9, 104-10, 104-N (referred to collectively as safety devices 104), area 105, and pre-determined paths 106-1, 106-2.

As described above, US 102 can be utilized to service safety devices 104. For example, US 102 can ensure safety devices 104 operate as intended in a situation in which an emergency event is taking place. As used herein, the term “US” refers to vehicle without a human pilot onboard (e.g., a drone or robot).

In some examples, US 102 may be an unmanned aerial system (UAS). As used herein, the term “UAS” refers to an aircraft without a human pilot onboard. For example, the UAS can be an aircraft that can be operated autonomously and/or by remote control. US 102 can be, for example, a single rotary UAS or multi-rotor UAS such as a tricopter, quadcopter, hexacopter, octocopter, etc. In some embodiments, US 102 may include multi-rotor positioning including Quad I, Quad X, Hex I, Hex V, Hex Y, Hex IY, Oct X, Oct I, Oct V, among other examples of rotor positioning.

In some examples, US 102 may be an unmanned ground system (UGS). As used herein, the term “UGS” refers to a ground-based vehicle without a human operator onboard (e.g., a robot). For example, the UGS can be a ground-based vehicle that can be operated autonomously and/or by remote control. US 102 can be, for example, a ground-based vehicle including wheels, continuous tracks (e.g., a continuous band of treads or track plates driven by two or more wheels), among other types of ground-based vehicles.

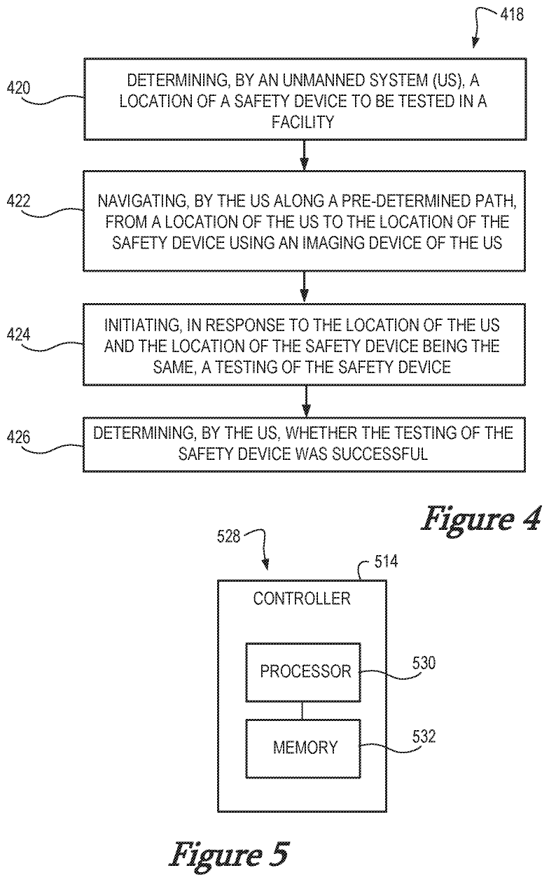

Although not illustrated in FIG. 1 for clarity and so as not to obscure embodiments of the present disclosure, US 102 can include a controller. The controller can include a processor and a memory to initiate a test of safety devices 104, as is further described in connection with FIG. 4.

US 102 can, via the controller, determine a location of a particular safety device 104 of the safety devices 104 to be tested. As described above, a safety device 104 can detect and/or report a change in an environment in which the safety device 104 is located. Accordingly, safety devices 104 may be tested to ensure proper operation.

In some examples, a particular safety device (e.g., safety device 104-1) can be selected for testing. The particular safety device 104-1 for testing can be communicated to US 102 from a computing device (e.g., not illustrated in FIG. 1). For instance, the particular safety device 104-1 for testing can be communicated from the computing device to US 102 via a network relationship. The computing device may be a building management system, a building operations center, a remote server, etc. The network relationship can, in some examples, be a wired or wireless network. In an example of a wireless network, US 102 can include a wireless transmitter and wireless receiver to communicate wirelessly with the computing device via the network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Worldwide Interoperability for Microwave Access (WiMAX), infrared (IR) communication, Public Switched Telephone Network (PSTN), radio waves, and/or the Internet, among other types of network relationships.

As described above, US 102 can determine a location of the safety device to be tested. For example, safety device 104-1 may be selected for testing and can be communicated to US 102. US 102 can then determine a location of safety device 104-1 via the controller of US 102. US 102 can determine a location of safety device 104-1 by requesting a pre-determined location of safety device 104-1 from the remote computing device (e.g., not illustrated in FIG. 1), and the remote computing device can transmit the location of safety device 104-1 to US 102.

The location of safety device 104-1 (e.g., and other safety devices 104) may be included in a safety device database accessible to the remote computing device. The safety device database may include safety device information regarding safety devices 104. For instance, the safety device database may include a device identification number, safety device type, manufacturer, model number, installation date, and location (e.g., within a facility 101) for each safety device 104.

US 102 can determine its own location via the controller. For example, US 102 may determine its location within the facility 101 and compare the current location of US 102 to the location of safety device 104-1. US 102 can determine its own location by communicating with the remote computing device, using an onboard imaging device, a global positioning system (GPS), and/or Wi-Fi, among other examples.

US 102 can navigate to the location of safety device 104-1 in response to the location of the safety device 104-1 being different from the location of US 102. For instance, as illustrated in FIG. 1, US 102 can be located in area 103. As described herein, the starting location of US 102 can be illustrated by the solid line around US 102. That is, US 102 can be located in a different location (e.g., area 103) than the location of safety device 104-1 (e.g., area 105). Accordingly, US 102 can navigate from its current location in area 103 to the location of safety device 104-1 located in area 105 in facility 101. In some examples, the current location of US 102 (e.g., in area 103) can be a US storage area in facility 101. In some examples, the current location of US 102 (e.g., in area 103) can be the location of another safety device (e.g., not illustrated in FIG. 1).

US 102 can include an imaging device. As used herein, the term “imaging device” refers to an optical device to capture still images and/or record moving images which can be stored in a physical medium. US 102 can navigate to the location of the safety device 104-1 using the imaging device and determine whether a test of the safety device 104-1 was successful using the imaging device, among other examples as is further described herein.

As described above, in some examples US 102 can be a UAS. In such an example, US 102 can fly to the location of safety device 104-1 using a pre-determined path 106-1. As used herein, the term “path” refers to a defined route from a first specified location to a second specified location. In an example in which US 102 is a UAS, the pre-determined paths 106 can be a pre-determined flight path that includes a specified altitude. For example, the pre-determined path 106-1 can be a pre-determined flight path from a first specified location (e.g., the current location of US 102 in area 103 of facility 101) to a second specified location (e.g., the location of safety device 104-1 in area 105 of facility 101) at a specified altitude.

As described above, in some examples US 102 can be a UGS. In such an example, US 102 can navigate to the location of safety device 104-1 along the ground via the wheels or continuous tracks included on the UGS using pre-determined path 106-1. For example, the pre-determined path 106-1 can be a route from a first specified location (e.g., the current location of US 102 in area 103 of facility 101) to a second specified location (e.g., the location of safety device 104-1 in area 105 of facility 101).

The pre-determined path 106-1 can be a navigable path that is previously mapped within facility 101. For example, facility 101 can include a map having objects with pre-determined coordinates. The pre-determined path 106-1 can be a route through facility 101 that utilizes the pre-determined coordinates of objects on the map of facility 101 to guide US 102 around objects in facility 101 to the location of safety device 104-1.

The pre-determined path 106-1 can be preprogrammed. In some examples, the US 102 may be navigated (e.g., flown or driven) by a user in a navigation path programming mode such that US 102 captures coordinates and images using the imaging device as the user navigates US 102 from a first location to a second location. In some examples, the coordinates along each point of the navigation path may be preprogrammed without navigating the US 102 around facility 101 such that US 102 can automatically navigate to each consecutive point of the path. The coordinates and/or images captured during the preprogramming stage can be utilized by US 102 to navigate along the pre-determined path 106.

Although the pre-determined path 106 is described above as being from a location of the US 102 in area 103 to safety device 104-1 located in area 105, embodiments of the present disclosure are not so limited. For example, pre-determined paths can be created for any location of US 102 within facility 101 to any other location within facility 101. For example, pre-determined paths may be created for US 102 to navigate from its location in area 103 to any other safety device 104, to navigate from its location at a particular safety device 104 to another safety device 104, to navigate from its location at a particular safety device 104 to a drone storage area, etc.

As described above, US 102 can automatically navigate from its location in area 103 to the location of safety device 104-1 (e.g., or any other safety device in facility 101) along a pre-determined path 106-1. However, embodiments of the present disclosure are not so limited. In some examples, US 102 can navigate from its location in area 103 to the location of safety device 104-1 in response to a user input from an input device. For example, US 102 may communicate with an input device (e.g., being used by a user) that can generate/send control signals to US 102 to cause US 102 to maneuver and/or navigate within facility 101. The input device may include buttons, switches, knobs, levers, keys, trackballs, touchpads, microphones, motion sensors, heat sensors, inertial sensors, touch sensors, and/or combinations thereof to generate/send control signals to US 102. Further, the input device may include a command line interface (CLI), graphical user interface (GUI), a voice interface, an Internet-based user interface, and/or combinations thereof to generate/send control signals to US 102. In some examples, images and/or video from the imaging device on US 102 can be displayed on the GUI of the input device for the user to view.

Although not illustrated in FIG. 1 for clarity and so as not to obscure embodiments of the present disclosure, US 102 can include a test kit. As used herein, the term “test kit” refers to a system including components designed to provide a detectable change in an environment to cause a response from a safety device. For example, the test kit included on US 102 can perform a particular action to cause a detectable change in an environment so as to cause safety device 104-1 to detect the change in the environment caused by the particular action performed by the test kit, as is further described herein.

US 102 can initiate a testing of the safety device 104-1 using the test kit in response to the location of the US 102 and the location of the safety device 104-1 being the same. As illustrated in FIG. 1, the location of US 102 being the same as the location of safety device 104-1 can be illustrated by a dashed line around US 102. US 102 can initiate testing of safety device 104-1 by using the test kit included in US 102 to cause the safety device to activate. For instance, the test kit can perform a particular action to cause a detectable change in the environment safety device 104-1 is located to test safety device 104-1 (e.g., determine whether the safety device activates in response to the detectable change). That is, US 102 can use the test kit to determine whether safety device 104-1 can detect the change in the environment caused by the test kit included on US 102.

In an example, safety device 104-1 can be a smoke detector. As used herein, the term “smoke detector” refers to a device that senses smoke. The smoke detector can be an ionization smoke detector, photoelectric smoke detector, aspirating smoke detector, and/or laser smoke detector, among other types of smoke detectors.

In such an example, testing of the safety device 104-1 can include the test kit included on US 102 generating smoke to interact with the smoke detector. For example, the controller included on US 102 can cause components in the test kit to generate smoke to cause a detectable change in an environment (e.g., the presence of smoke) around the smoke detector so as to cause the smoke detector to detect the smoke generated by the test kit.

In some examples, the test kit can include an aerosol stimulant. For example, the controller included on US 102 can cause the test kit to generate aerosol (e.g., smoke) to interact with the smoke detector. That is, the aerosol can cause the detectable change in the environment (e.g., the presence of smoke or other aerosol) around the smoke detector to activate the smoke detector.

In some examples, the test kit can cause a chemical reaction to occur between substances included in the test kit. The chemical reaction can be an exothermic reaction and/or an electrochemical reaction. As used herein, the term “exothermic reaction” refers to a chemical reaction that release energy through light and/or heat (e.g., thermal energy). As used herein, the term “electrochemical reaction” refers to a process caused by the passage of an electric current between two substances. For example, an electric current can be passed between two substances included in the test kit to cause a chemical reaction to cause a detectable change in an environment around safety device 104-1. In some examples, the two substances can be magnesium and water. For instance, a reaction between magnesium and water can cause a detectable change in an environment around safety device 104-1 to test safety device 104-1. However, embodiments of the present disclosure are not limited to magnesium and water. For example, the substances included in the test kit to cause the chemical reaction to cause the detectable change in an environment around safety device 104-1 can be any other substances that can undergo a chemical reaction to cause a detectable change in an environment around a safety device 104.

In some examples, the controller included on US 102 can cause the test kit to generate a chemical reaction. The chemical reaction can produce smoke to interact with the smoke detector. That is, the smoke produced by the chemical reaction can cause the detectable change in the environment (e.g., the presence of smoke) around the smoke detector to activate the smoke detector.

In an example, safety device 104-1 can be a heat detector. As used herein, the term “heat detector” refers to a device that senses convected thermal energy using a heat sensitive element. The heat detector can be a rate-of-rise heat detector and/or a fixed temperature heat detector, among other types of heat detectors.

In such an example, testing of the safety device 104-1 can include the test kit included on US 102 generating thermal energy to interact with the heat detector. For example, the controller included on US 102 can cause components in the test kit to generate thermal energy to cause a detectable change in an environment (e.g., a particular rate in a rise of temperature that exceeds a threshold rate of temperature rise, or a temperature exceeding a particular threshold temperature) around the heat detector so as to cause the heat detector to detect the thermal energy generated by the test kit.

In some examples, the controller included on US 102 can cause the test kit to generate a chemical reaction. The chemical reaction can produce thermal energy to interact with the heat detector. That is, the thermal energy produced by the chemical reaction can cause the detectable change in the environment (e.g., the presence of thermal energy) around the heat detector to activate the heat detector.

In an example, safety device 104-1 can be a carbon monoxide (CO) detector. As used herein, the term “CO detector” refers to a device that senses CO gas. The smoke detector can be an opto-chemical CO detector, biomimetic CO detector, electrochemical CO detector, and/or a semiconductor CO detector, among other types of CO detectors.

In such an example, testing of the safety device 104-1 can include the test kit included on US 102 generating CO to interact with the CO detector. For example, the controller included on US 102 can cause components in the test kit to generate CO to cause a detectable change in an environment (e.g., the presence of CO) around the CO detector so as to cause the CO detector to detect the CO generated by the test kit.

In some examples, the test kit can include an aerosol CO stimulant. The aerosol CO stimulant can be hydrogen, CO, etc. For example, the controller included on US 102 can cause the test kit to generate aerosol CO stimulant to interact with the CO detector. That is, the aerosol CO can cause the detectable change in the environment (e.g., the presence of CO) around the CO detector to activate the CO detector.

In some examples, the controller included on US 102 can cause the test kit to generate a chemical reaction. The chemical reaction can produce CO to interact with the CO detector. That is, the CO produced by the chemical reaction can cause the detectable change in the environment (e.g., the presence of CO) around the CO detector to activate the CO detector. In some examples, the chemical reaction can produce hydrogen to interact with the CO detector. That is, the hydrogen produced by the chemical reaction can cause the detectable change in the environment (e.g., the presence of hydrogen) around the CO detector to activate the CO detector due to cross sensitivity of the sensor to hydrogen.

As described above, the test kit included on US 102 can be utilized to test different types of safety devices 104 using particular components included in a test kit. In some examples, the test kit included on US 102 can include multiple test mechanisms and/or components to test multiple safety devices 104.

For example, the controller included on US 102 can determine a type of safety device 104 to be tested. As previously described above, US 102 can include an imaging device. The imaging device can capture images of the safety device 104. The controller can determine, based on the captured images, the type of safety device 104. For example, based on captured images by the imaging device of US 102, the controller included on US 102 can determine that safety device 104-1 is a smoke detector, heat detector, and/or CO detector, among other types of safety devices.

The controller included on US 102 can determine which of the test mechanisms included in the test kit to use for testing safety device 104-1 based on the determined type of safety device 104-1. For example, in response to the controller determining the safety device 104-1 is a smoke detector, the controller can determine an aerosol smoke test mechanism and/or a chemical reaction test mechanism may be used to test the smoke detector. As an additional example, in response to the controller determining the safety device 104-1 is a heat detector, the controller can determine a chemical reaction test mechanism may be used to test the heat detector. As an additional example, in response to the controller determining the safety device 104-1 is a CO detector, the controller can determine an aerosol smoke test mechanism and/or a chemical reaction test mechanism may be used to test the CO detector.

Based on the controller determining the type of safety device 104, the controller can initiate testing of the safety device 104 using the determined test mechanism. For example, in response to the controller determining the safety device 104-1 is a smoke detector, the controller can initiate testing of the smoke detector by causing the test kit to generate aerosol via an aerosol test mechanism and/or a chemical reaction test mechanism. As an additional example, in response to the controller determining the safety device 104-1 is a heat detector, the controller can initiate testing of the heat detector by causing the test kit to generate smoke via a chemical reaction test mechanism. As an additional example, in response to the controller determining the safety device 104-1 is a CO detector, the controller can initiate testing of the CO detector by causing the test kit to generate CO via an aerosol CO test mechanism and/or a chemical reaction test mechanism.

US 102 can determine whether the test of a particular safety device of the safety devices 104 was successful. For example, the imaging device included on US 102 can capture an activation of a particular safety device of the safety devices 104 to determine whether the test of the particular safety device of the safety devices 104 was successful. For example, the safety device 104-1 can emit a visual indication of activation in response to a detected change in its environment. The visual indication can be captured by the imaging device. In response to the controller determining the safety device 104-1 emitted the visual indication, the controller can determine the test of safety device 104-1 was successful. If the visual indication is not present, the controller can determine the test of safety device 104-1 was not successful. In some examples, safety device 104-1 may emit an audible indication (e.g., an alarm) in response to a detected change in its environment. US 102 may include a microphone to capture the audible indication. In response to the controller determining the safety device 104-1 emitted the audible indication, the controller can determine the test of safety device 104-1 was successful. If the audible indication is not present, the controller can determine the test of safety device 104-1 was not successful.

Although the safety device 104-1 is described above as emitting a visual or an audible indication of activation, embodiments of the present disclosure are not so limited. In one example, safety device 104-1 may transmit a signal to a building management system, a building operations center, etc. to indicate success or failure of the test. In another example, safety device 104-1 may transmit a signal to the US 102 wirelessly via Bluetooth, Wi-Fi, Zigbee, etc.

Safety devices 104 located in facility 101 may be tested periodically. However, safety devices 104 may become covered in dust and/or other debris over time. The dust and/or other debris may prevent successful activation when being tested and/or in an emergency event.

Accordingly, the test kit included on US 102 can clean a particular safety device of the safety devices 104 before testing of the safety device. For example, the test kit may include a cleaning solution to clean a particular safety device of the safety devices 104. For instance, the cleaning solution may include compressed air, water, aerosol cleaning solution, and/or any other cleaning solution. The cleaning solution may be applied to a particular safety device of the safety devices 104 by the test kit. After cleaning the particular safety device of the safety devices 104, the US 102 can initiate testing of the particular safety device of the safety devices 104 by the test kit, as previously described above.

Following testing of safety device 104-1, in some examples US 102 can test another safety device (e.g., safety device 104-2). In order to test another safety device 104-2, US 102 can navigate along another pre-determined path 106-2 from the location of safety device 104-1 to the location of safety device 104-2. Once at the location of safety device 104-2, US 102 can utilize the test kit to test safety device 104-2. In some examples, the safety device 104-2 can be the same type of safety device as safety device 104-1. In some examples, the safety device 104-2 can be a different type of safety device as safety device 104-1. The controller of US 102 can select a type of test kit to test safety device 104-2 based on the type of safety device, as previously described above.

Following testing of safety device 104-1, in some examples US 102 can navigate along another pre-determined path from the location of the safety device 104-1 to a location of a US storage area in the facility 101. For example, area 103 may be the US storage area in the facility 101. US 102 can navigate along pre-determined path 106-1 back to the US storage area or along a different pre-determined path back to the US storage area.

Although the examples described above are described with respect to safety devices 104-1 and/or 104-2, embodiments of the present disclosure are not so limited. For example, the embodiments described herein are applicable to any of the safety devices 104.

US for safety device testing, according to the present disclosure, can allow for safe and efficient device testing of safety devices. For example, the US can allow for safe testing of safety devices which may be located in an area which may pose safety risks for a technician to access. Accordingly, a risk of injury to a technician can be reduced.

FIG. 2 is an example of a system 208 including a safety device 204 and an unmanned aerial system (UAS) 211 for safety device testing, in accordance with one or more embodiments of the present disclosure. As shown in FIG. 2, UAS 211 can include test kit 210, imaging device 212, and controller 214. UAS 211 can be, for example, US 102 previously described in connection with FIG. 1. Safety device 204 can be, for example, any one of safety devices 104-1, 104-2, 104-3, 104-4, 104-5, 104-6, 104-7, 104-8, 104-9, 104-10, 104-N, previously described in connection with FIG. 1.

As previously described in connection with FIG. 1, UAS 211 can fly to the location of safety device 204 using a pre-determined flight path. The pre-determined flight path can be a route from a first location (e.g., of the UAS 202) to the location of safety device 204. UAS 211 can utilize the pre-determined flight path in conjunction with a pre-determined map of the facility having pre-determined locations of safety devices within the facility to fly to the location of safety device 204.

While UAS 211 is flying along the pre-determined flight path, imaging device 212 can capture images of the locations of the UAS 211 along the pre-determined flight path. For example, imaging device 212 can be a camera and can capture images at points along the pre-determined flight path as UAS 211 is flying from a first location to a location of safety device 204.

Controller 214 can compare the captured images to previously captured images along the pre-determined flight path. For example, imaging device 212 can capture an image at a location along the pre-determined flight path. Controller 214 can compare the image at the location along the pre-determined flight path with an image previously captured at the same location along the pre-determined flight path.

In response to the image captured by imaging device 212 at the location along the pre-determined flight path not matching the previously captured image at the same location along the pre-determined flight path, controller 214 can cause UAS 211 to correct the location of UAS 211 to the pre-determined flight path. For example, if the image captured by imaging device 212 at the location along the pre-determined flight path does not match the previously captured image at the same location along the pre-determined flight path, controller 214 can determine UAS 211 has strayed off of the pre-determined flight path. That is, controller 214 can cause UAS 211 to course-correct back to the pre-determined flight path if it has strayed off of the pre-determined flight path. Course correct may include correcting the altitude of the UAS 211 (e.g., up or down), correcting a latitudinal orientation of the UAS 211, correcting a longitudinal orientation of the UAS 211, etc.

Once UAS 211 is at the location of safety device 204, UAS 211 can initiate a testing of safety device 204 using test kit 210. Test kit 210 can perform a particular action to cause a detectable change in the environment around safety device 204 to determine whether safety device 204 can detect the change in the environment caused by test kit 210 and activate accordingly.

In an example in which safety device 204 is a smoke detector, test kit 210 can generate aerosol (e.g., smoke) to determine whether safety device 204 can detect the aerosol generated by test kit 210. Test kit 210 can generate aerosol via an aerosol smoke stimulant, a chemical reaction that produces smoke, among other examples.

In an example in which safety device 204 is a heat detector, test kit 210 can generate thermal energy to determine whether safety device 204 can detect the thermal energy generated by test kit 210. Test kit 210 can generate thermal energy via a chemical reaction. That is, test kit 210 can be an electrochemical heater to generate thermal energy.

In an example in which safety device 204 is a CO detector, test kit 210 can generate gas (e.g., CO, hydrogen, or other gases detectable by a CO detector) to determine whether safety device 204 can detect the gas generated by test kit 210. Test kit 210 can generate gas via an aerosol stimulant, a chemical reaction that produces gas detectable by the CO detector, among other examples.

In some examples, test kit 210 can include multiple mechanisms to test multiple safety devices 204. For example, test kit 210 may include an aerosol smoke stimulant to generate smoke to test a smoke detector, generate thermal energy via a chemical reaction to test a heat detector, and the chemical reaction to generate gas to test a CO detector, and/or combinations thereof. In some examples, test kit 210 may include a single mechanism to test one safety device 204. For example, test kit 210 may include aerosol smoke stimulant to test a smoke detector, and following testing of the smoke detector, UAS 211 may make a return flight to an area to remove the used test kit 210 and load a new test kit to test a different type of safety device.

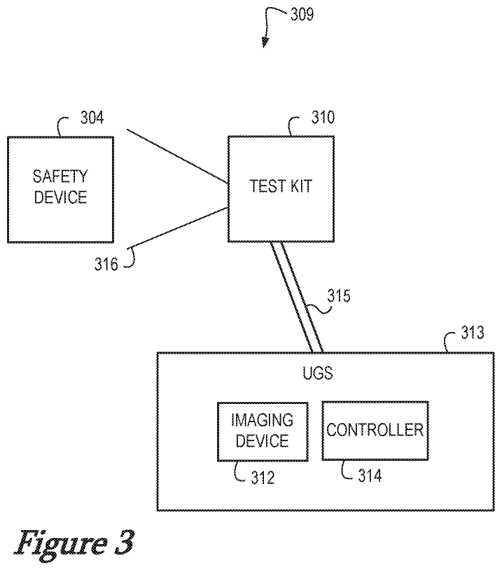

FIG. 3 is an example of a system 309 including a safety device 304 and an unmanned ground system (UGS) 313 for safety device testing, in accordance with one or more embodiments of the present disclosure. As shown in FIG. 3, UGS 313 can include test kit 310, imaging device 312, and controller 314. UGS 313 can be, for example, US 102 previously described in connection with FIG. 1. Safety device 304 can be, for example, any one of safety devices 104-1, 104-2, 104-3, 104-4, 104-5, 104-6, 104-7, 104-8, 104-9, 104-10, 104-N, previously described in connection with FIG. 1.

As previously described in connection with FIG. 1, UGS 313 can navigate along the ground using wheels and/or continuous tracks to the location of safety device 304 using a pre-determined path. The pre-determined path can be a route from a first location (e.g., of the UGS 313) to the location of safety device 304. UGS 313 can utilize the pre-determined path in conjunction with a pre-determined map of the facility having pre-determined locations of safety devices within the facility to navigate to the location of safety device 304.

While UGS 313 is navigating along the pre-determined path, imaging device 312 can capture images of the locations of the UGS 313 along the pre-determined path. For example, imaging device 312 can be a camera and can capture images at points along the pre-determined path as UGS 313 is navigating from a first location to a location of safety device 304.

Controller 314 can compare the captured images to previously captured images along the pre-determined path. For example, imaging device 312 can capture an image at a location along the pre-determined path. Controller 314 can compare the image at the location along the pre-determined path with an image previously captured at the same location along the pre-determined path.

In response to the image captured by imaging device 312 at the location along the pre-determined path not matching the previously captured image at the same location along the pre-determined path, controller 314 can cause UGS 313 to correct the location of UGS 313 to the pre-determined path. For example, if the image captured by imaging device 312 at the location along the pre-determined path does not match the previously captured image at the same location along the pre-determined path, controller 314 can determine UGS 313 has strayed off of the pre-determined path. That is, controller 314 can cause UGS 313 to course-correct back to the pre-determined path if it has strayed off of the pre-determined path. Course correct may include adjusting a latitudinal orientation of the UGS 313, correcting a longitudinal orientation of the UGS 313, etc.

Once UGS 313 is at the location of safety device 304, UGS 313 can initiate a testing of safety device 304 using test kit 310. Test kit 310 can perform a particular action to cause a detectable change in the environment around safety device 304 to determine whether safety device 304 can detect the change in the environment caused by test kit 310 and activate accordingly.

UGS 313 can include an extension mechanism 315. As used herein, the term “extension mechanism” refers to a mechanism that can lengthen and shorten. For example, extension mechanism 315 can extend to position test kit 310 in proximity with safety device 304 via extension mechanism 315. In some examples, extension mechanism 315 can include telescoping sections such that extension mechanism 315 can position test kit 310 in proximity with safety device 304, among other examples.

In an example in which safety device 304 is a smoke detector, test kit 310 can generate aerosol (e.g., smoke) to determine whether safety device 304 can detect the aerosol generated by test kit 310. Test kit 310 can generate aerosol via an aerosol smoke stimulant, a chemical reaction that produces smoke, among other examples.

In an example in which safety device 304 is a heat detector, test kit 310 can generate thermal energy to determine whether safety device 304 can detect the thermal energy generated by test kit 310. Test kit 310 can generate thermal energy via a chemical reaction. That is, test kit 310 can be an electrochemical heater to generate thermal energy.

In an example in which safety device 304 is a CO detector, test kit 310 can generate gas (e.g., CO, hydrogen, or other gases detectable by a CO detector) to determine whether safety device 304 can detect the gas generated by test kit 310. Test kit 310 can generate gas via an aerosol stimulant, a chemical reaction that produces gas detectable by the CO detector, among other examples.

In some examples, test kit 310 can include multiple mechanisms to test multiple safety devices 304. For example, test kit 310 may include an aerosol smoke stimulant to generate smoke to test a smoke detector, generate thermal energy via a chemical reaction to test a heat detector, and the chemical reaction to generate gas to test a CO detector, and/or combinations thereof. In some examples, test kit 310 may include a single mechanism to test one safety device 304. For example, test kit 310 may include aerosol smoke stimulant to test a smoke detector, and following testing of the smoke detector, UGS 313 may make a return trip to an area to remove the used test kit 310 and load a new test kit to test a different type of safety device.

FIG. 4 is an example of a method 418 for safety device testing using a US, in accordance with one or more embodiments of the present disclosure. Method 418 may be performed by, for example, a US (e.g., US 102, UAS 211, and/or UGS 313, previously described in connection with FIGS. 1-3, respectively) having a controller (e.g., controller 214, 314, previously described in connection with FIGS. 2 and 3, respectively) and a test kit (e.g., test kit 210, 310, previously described in connection with FIGS. 2 and 3, respectively).

At block 420, the method 418 can include determining, by a US, a location of a safety device to be tested in a facility. For example, a particular safety device may be selected for testing. The particular safety device selected for testing may include a pre-determined location within the facility. The pre-determined location may be transmitted to the US, and the US can determine the location of the safety device to be tested.

At block 422, the method 418 can include navigating, by the US along a pre-determined path, from a location of the US to the location of the safety device using an imaging device of the US. For example, a controller of the US can determine the location of the US and compare it with the location of the safety device to be tested. In response to the location of the US being different from the location of the safety device to be tested, US can navigate from the location of the US to the location of the safety device. The US can navigate to the location of the safety device along a pre-determined path through the facility. In some examples, the US can be a UAS, and the UAS can navigate from the location of the UAS to the location of the safety device by flying. In some examples, the US can be a UGS, and the UGS can navigate from the location of the UGS to the location of the safety device by navigating on the ground via wheels and/or continuous tracks of the UGS.

At block 424, the method 418 can include initiating, in response to the location of the US and the location of the safety device being the same, a testing of the safety device. The US can use a test kit included on the US to cause the safety device to activate. The test kit can be selected based on the type of safety device to be tested. For example, the US can use a test kit including an aerosol smoke stimulant to test a smoke detector, a test kit including materials of which can react with one another to cause a chemical reaction to test a heat detector and/or a CO detector, among other examples.

At block 426, the method 418 can include determining, by the US, whether the testing of the safety device was successful. For example, the safety device can emit an indication of activation. An imaging device or other device included on the US can capture the indication of activation, if present. In response, the controller of the US can determine, based on the indication of activation being present, a successful test of the safety device. The controller of the US can determine, based on the indication of activation not being present, an unsuccessful test of the safety device.

FIG. 5 is an example of a controller 514 for a US for safety device testing, in accordance with one or more embodiments of the present disclosure. Controller 514 can be, for example, controller 214, 314, previously described in connection with FIGS. 2 and 3, respectively.

As illustrated in FIG. 5, controller 514 can include a memory 532 and a processor 530. The memory 532 can be any type of storage medium that can be accessed by the processor 530 to perform various examples of the present disclosure. For example, the memory 532 can be a non-transitory computer readable medium having computer readable instructions (e.g., computer program instructions) stored thereon that are executable by the processor 530 for using a US for safety device testing in accordance with the present disclosure.

The memory 532 can be volatile or nonvolatile memory. The memory 532 can also be removable (e.g., portable) memory, or non-removable (e.g., internal) memory. For example, the memory 532 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 532 is illustrated as being located within controller 514, embodiments of the present disclosure are not so limited. For example, memory 532 can also be located internal to another computing resource (e.g., enabling computer readable instructions to be downloaded over the Internet or another wired or wireless connection).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. An unmanned system (US) for safety device testing, comprising:
a test kit;
a memory; and
a processor configured to execute instructions stored in the memory to:
determine a location of a safety device to be tested;
navigate, in response to the location of the safety device being different from a location of the US, the US to the location of the safety device; and
initiate, in response to the location of the US and the location of the safety device being the same, a testing of the safety device using the test kit.

2. The US of claim 1, wherein:
the safety device is a smoke detector; and
the testing of the safety device includes using the test kit to generate aerosol to interact with the smoke detector.

3. The US of claim 1, wherein:
the safety device is a heat detector; and
the testing of the safety device includes using the test kit to generate thermal energy to interact with the heat detector.

4. The US of claim 1, wherein:
the safety device is a carbon monoxide (CO) detector; and
the testing of the safety device includes using the test kit to generate CO to interact with the CO detector.

5. The US of claim 1, wherein initiating the testing of the safety device includes causing a chemical reaction between a plurality of substances included in the test kit to occur.

6. The US of claim 1, wherein:
the US is an unmanned aerial system (UAS);
the US includes at least one imaging device; and
the processor is configured to execute the instructions to navigate the US to the location of the safety device by flying the UAS to the location of the safety device using the at least one imaging device along a pre-determined flight path from the location of the US to the location of the safety device based on a pre-determined map and a pre-determined location of the safety device.

7. The US of claim 1, wherein the processor is configured to execute the instructions to:
capture, using at least one imaging device of the US, at least one image of the location of the US along the pre-determined path;
compare the at least one captured image to a previously captured image at the location of the US along the pre-determined path; and
in response to the at least one captured image not matching the previously captured image, correct the location of the US to the pre-determined path.

8. The US of claim 1, wherein:
the US is an unmanned ground system (UGS);
the US includes at least one imaging device; and
the processor is configured to execute the instructions to navigate the US to the location of the safety device using the at least one imaging device.

9. The US of claim 8, wherein:
the UGS includes an extension mechanism connected to the test kit; and
the processor is configured to execute the instructions to position the test kit in proximity with the safety device via the extension mechanism prior to initiating the testing of the safety device.

10. An unmanned system (US) for safety device testing, comprising:
a test kit;
an imaging device; and
a controller configured to:
determine a location of a safety device to be tested;
cause the US to navigate from a location of the US to the location of the safety device along a pre-determined path using the imaging device in response to the location of the safety device being different from the location of the US; and
initiate, in response to the location of the US and the location of the safety device being the same, a testing of the safety device using the test kit.

11. The system of claim 10, wherein the testing of the safety device includes causing a smoke detector to activate as a result of at least one of:
a chemical reaction generated by the test kit that produces smoke to interact with the smoke detector; and
aerosol generated by the test kit to interact with the smoke detector.

12. The system of claim 10, wherein the testing of the safety device includes causing a heat detector to activate as a result of a chemical reaction generated by the test kit that produces thermal energy to interact with the heat detector, wherein the chemical reaction is an exothermic reaction.

13. The system of claim 10, wherein the testing of the safety device includes causing a carbon monoxide (CO) detector to activate as a result of at least one of:
a chemical reaction generated by the test kit that produces CO to interact with the CO detector; and
aerosol CO generated by the test kit to interact with the CO detector.

14. The system of claim 10, wherein the controller is configured to initiate the testing of the safety device by causing a chemical reaction between magnesium and water included in the test kit to interact with the safety device.

15. The system of claim 10, wherein the test kit includes a plurality of test mechanisms and wherein the controller is configured to:
determine a type of the safety device to be tested; and
determine which one of the plurality of test mechanisms of the test kit to use for the testing of the safety device based on the determined type; and
initiate the testing of the safety device using the determined test mechanism.

16. A method for safety device testing using an unmanned system (US), comprising:
determining, by the US, a location of a safety device to be tested in a facility;
navigating, by the US along a pre-determined path, from a location of the US to the location of the safety device in the facility using an imaging device of the US in response to the location of the safety device being different from the location of the US;
initiating, in response to the location of the US and the location of the safety device being the same, a testing of the safety device by using a test kit of the US to cause the safety device to activate; and
determining, by the US, whether the testing of the safety device was successful.

17. The method of claim 16, wherein the method includes capturing, via the imaging device, an activation of the safety device to determine whether the test of the safety device was successful.

18. The method of claim 16, wherein the method includes:
cleaning, by the test kit, the safety device; and
initiating the testing of the safety device after cleaning the safety device.

19. The method of claim 16, wherein the method includes navigating, by the US along another pre-determined path, from the location of the safety device to a location of another safety device in the facility.

20. The method of claim 16, wherein the method includes navigating, by the US along another pre-determined path, from the location of the safety device to a location of a US storage area in the facility.
